(19) United States
(12) Patent Application Publication
(10) Pub. No.: US 2017/0046159 A1
(43) Pub. Date: Feb. 16, 2017

(54) POWER EFFICIENT FETCH ADAPTATION

(71) Applicant: QUALCOMM Incorporated, San Diego, CA (US)

(72) Inventors: Shivam PRIYADARSHI, Raleigh, NC (US); Rami Mohammad AL SHEIKH, Raleigh, NC (US); Raguram DAMODARAN, Raleigh, NC (US)

(21) Appl. No.: 14/827,262

(22) Filed: Aug. 14, 2015

(51) Int. Cl. G06F 9/38; G06F 12/08

(52) U.S. Cl. CPC G06F 9/3804; G06F 12/0875; G06F 2212/452

(57) ABSTRACT

Systems and methods relate to an instruction fetch unit of a processor, such as a superscalar processor. The instruction fetch unit includes a fetch bandwidth predictor (FBWP) configured to predict a number of instructions to be fetched in a fetch group of instructions in a pipeline stage of the processor. A first entry of the FBWP corresponding to the fetch group corresponds to a prediction of the number of instructions to be fetched, based on occurrence and location of a predicted taken branch instruction in the fetch group and a confidence level associated with the predicted number in the prediction field. The instruction fetch unit is configured to fetch only the predicted number of instructions, rather than the maximum number of entries that can be fetched in the pipeline stage, if the confidence level is greater than a predetermined threshold. In this manner, wasteful fetching of instructions is avoided.

### FIELD OF DISCLOSURE

Disclosed aspects relate to instruction fetching in processors. More specifically, exemplary aspects relate to improved power efficiency of instruction fetch units used for fetching one or more instructions.

### BACKGROUND

Some processors are designed to exploit instruction-level parallelism by fetching and executing multiple instructions in parallel, for example, in each clock cycle. An instruction fetch unit of a processor (e.g., a superscalar processor) may be configured to fetch multiple instructions, referred to as a fetch quantum or a fetch group of instructions, from an instruction cache in a single cycle and dispatch the group of instructions to two or more functional units in an execution pipeline, where the group of instructions can be processed in parallel. However, the presence of control flow changing instructions, such as branch instructions in the group of instructions can result in wasteful fetching of instructions, resulting in wastage of power and resources. This wastage will be explained below, with reference to a conventional instruction fetch unit design.

In FIG. 1A, a conventional pipelined instruction fetch unit 100 is illustrated for operation of a processor (not shown). Instruction fetch unit 100, as shown, is configured to access instruction cache 110 in a first fetch stage (or fetch stage 1) of the pipeline and perform branch prediction using branch predictor 112 in a subsequent, second fetch stage (or fetch stage 2) of the pipeline. Fetch stage 1 is formed between pipeline latches 102 and 104. Fetch stage 2 is formed between pipeline latch 104 and a subsequent pipeline latch (not shown).

With combined reference now to FIGS. 1A-B, an example flow of instructions through the pipelined fetch stages 1 and 2 is described. In a first clock cycle (e.g., “cycle 1” of FIG. 1B), in fetch stage 1, a fetch group of a fetch width of W (=5) sequential instructions I1, I2, I3, I4, and I5 (also referred to as a first group of W instructions) are read or fetched from instruction cache 110, starting from an instruction address pointed to by current program counter (PC) 120. Respectively, these instructions relate to “add,” “branch,” “subtract,” “multiply,” and “or” instructions which are intended to be processed in parallel by the processor. These first group of W instructions are fed to fetch stage 2 in the second clock cycle (cycle 2), where they are decoded into the above five instructions.

However, the presence of instruction I2, which is a branch instruction, in the first group of W instructions can change control flow of the subsequent instructions, not only for one or more instructions in the first group of W instructions, but also for one or more instructions in one or more following groups of instructions. For example, if the branch instruction of instruction I2 is taken, subsequent instructions will need to be fetched from a branch target address of the branch instruction. Otherwise, if the branch instruction is not taken, the control flow may remain unchanged.

In order to determine where to start fetching the next (second) group of W instructions from in cycle 2, fetch stage 1 comprises logic to calculate next PC 116. Next PC 116 is the next address or PC from which instructions will be fetched in cycle 2, which can depend on whether there were control flow changing branch instructions in the first fetch group. In fetch stage 2, branch predictor 112 provides a prediction of whether the branch instruction I2 will be taken or not taken, and accordingly provides predicted branch target address 114. However, predicted branch target address 114 is only available in cycle 2 from fetch stage 2. In fetch stage 1, cycle 1, adder 106 adds the current PC 120 to offset 118, which is based on the fetch width (in this case, W=5) and instruction encoding size. This provides the next sequential address from which to start fetching the second group of W instructions (for the case when there is no change in control flow). Since the output of adder 106 is available in cycle 1 from fetch stage 1, mux 108 selects the output of adder 106 to access instruction cache 110 in cycle 2 to obtain the second group of W instructions. For the following third cycle (cycle 3, not shown), mux 108 will be able to select predicted branch target address 114 available from cycle 2 to access instruction cache 110, but the second group of W instructions would already have been fetched by this time.

Accordingly, in cycle 2, the second group of W instructions comprising I6, I7, I8, I9, and I10 (which are respectively shown as “and,” “divide,” “or,” “add,” and “subtract” instructions) are fetched by fetch stage 1, starting at next PC 116 assumed to be the output of adder 106, while waiting for predicted branch target address 114 to be obtained. In the example illustrated in FIG. 1B, this assumption turns out to be incorrect because I2 is predicted to be a taken branch with predicted branch target address 114 being different from the output of adder 106. Therefore, instructions following the taken branch instruction I2 will be discarded or flushed. The instructions following I2 that are to be discarded are classified into two categories in FIG. 1B. In a first category (type 1), instructions I3, I4, and I5 which follow I2 in the same first group of W instructions as I2, are discarded. In a second category (type 2) instructions I6, I7, I8, I9, and I10 in the second group of W instructions, which were incorrectly fetched because predicted branch target address 114 was not available earlier, are discarded. Instruction fetch unit 100 would then be redirected to fetch a new group of W instructions starting from predicted branch target address 114 in cycle 3. As seen, both type 1 and type 2 instructions are wasted (i.e., fetched but discarded before being executed) and involve accompanying wastage of power and resources.

Considering these types 1 and 2 in more detail, it is seen that type 2 instructions may not have been wasted if predicted branch target address 114 is available earlier, for example, in cycle 1, like the output of adder 106. This would have been possible if accessing instruction cache 110 and obtaining predicted branch target address 114 from branch predictor 112 was possible in the same pipeline stage, such as fetch stage 1. Some conventional implementations try to prevent wastage of type 2 instructions by performing instruction cache access and branch prediction in a single clock cycle.

FIG. 2 illustrates another conventional instruction fetch unit 200, which is designed to avoid wastage of type 2 instructions. Instruction fetch unit 200 is similar to instruction fetch unit 100 in many aspects, where functional units with like reference numerals perform similar functions and accordingly a detailed explanation of these will not be repeated. Focusing on the significant differences between instruction fetch units 100 and 200, instruction fetch unit 200 is designed with only a single pipeline stage, fetch stage 1, which is formed between pipeline latches 102 and 204. As can be seen, pipeline latch 204 is placed in such a manner as to accommodate branch predictor 212 within fetch stage 1. This means that instruction cache 110 can be accessed to fetch the first group of instructions in fetch stage 1, (e.g., in cycle 1), which can feed the instructions to branch predictor 212 in the same cycle (cycle 1). Branch predictor 212 can predict the direction and target address of any branch in the first group in fetch stage 1, cycle 1. For example, branch predictor 212 can provide the predicted branch target address 214 for branch instruction I2 in fetch stage 1, cycle 1. Mux 108 can therefore select predicted branch target address 214 as next PC 116 (which would not be possible in instruction fetch unit 100). Next PC 116 will be used to access instruction cache 110 in the following cycle, cycle 2. Thus, in cycle 2, a correct group of instructions can be fetched starting from predicted branch target address 214, which will eliminate wastage of type 2 instructions.

However, type 1 instructions would still be wasted, because, for example, instructions I3, I4, and I5 following the branch instruction I2 in the first group of instructions would still need to be discarded (once again, assuming that predicted branch target address 214 of I2 is different from the next sequential address output from adder 106). Only the remaining instructions in the first group (i.e., taken branch instruction I2 and instruction I1 preceding I2) will be provided to the next pipeline stage (not shown) of the processor for further processing.

Instruction caches are one of the most power hungry components of instruction fetch units. Thus, wasteful fetching of even the type 1 instructions which are eventually discarded, amount to significant power wastage. It is desirable to reduce or eliminate the power wastage resulting from unnecessary fetching of instructions (e.g., type 1 and type 2 instructions) which will eventually be discarded.

### SUMMARY

Exemplary aspects include systems and methods related to an instruction fetch unit designed for a processor, the instruction fetch unit capable of fetching a fetch group of one or more instructions per clock cycle. In some aspects, the processor may be a superscalar processor. The instruction fetch unit includes a fetch bandwidth predictor (FBWP) configured to predict a number of instructions to be fetched in a fetch group of instructions in a pipeline stage of the processor. An entry of the FBWP corresponding to the fetch group includes a prediction field comprising a prediction of the number of instructions to be fetched, based on occurrence and location of a predicted taken branch instruction in the fetch group and a confidence level associated with the predicted number in the prediction field. The instruction fetch unit is configured to fetch only the predicted number of instructions, rather than the maximum number of entries that can be fetched in the pipeline stage, if the confidence level is greater than a predetermined threshold. In this manner, wasteful fetching of instructions is avoided.

For example, an exemplary aspect includes a method of fetching instructions for a processor, the method comprising: predicting a number of instructions to be fetched in a fetch group of instructions, based at least in part on occurrence and location of a predicted taken branch instruction in a first fetch group of instructions, determining if a confidence level associated with the predicted number of instructions is greater than a predetermined threshold, and fetching the predicted number of instructions in a pipeline stage of the processor if the confidence level is greater than the predetermined threshold.

Another exemplary aspect includes an instruction fetch unit comprising: a fetch bandwidth predictor (FBWP) configured to predict a number of instructions to be fetched in a first fetch group of instructions in a pipeline stage of a processor. An entry of the FBWP corresponding to the first fetch group comprises a prediction field comprising a prediction of the number of instructions to be fetched, based on occurrence and location of a predicted taken branch instruction in the first fetch group, and a confidence level associated with the predicted number in the prediction field. The instruction fetch unit is configured to fetch the predicted number of instructions in the pipeline stage if the confidence level is greater than a predetermined threshold.

Yet another exemplary aspect relates to a system comprising means for predicting a number of instructions to be fetched in a first fetch group of instructions, based at least in part on occurrence and location of predicted taken branch instruction in the first fetch group of instructions, means for determining if a confidence level associated with the predicted number of instructions is greater than a predetermined threshold, and means for fetching the predicted number of instructions in a pipeline stage of the processor if the confidence level is greater than a predetermined threshold.

Another exemplary aspect pertains to a non-transitory computer-readable storage medium comprising code, which, when executed by a processor, causes the processor to perform operations for fetching instructions, the non-transitory computer-readable storage medium comprising code for predicting a number of instructions to be fetched in a first fetch group of instructions, based at least in part on occurrence and location of a predicted taken branch instruction in the first fetch group, code for determining if a confidence level associated with the predicted number of instructions is greater than a predetermined threshold, and code for fetching the predicted number of instructions from an instruction cache if the confidence level is greater than the predetermined threshold.

### BRIEF DESCRIPTION OF THE DRAWINGS

The accompanying drawings are presented to aid in the description of aspects of the invention and are provided solely for illustration of the aspects and not limitation thereof.

FIGS. 1A-B illustrate a conventional two-stage instruction fetch unit.

FIG. 2 illustrates a conventional single stage instruction fetch unit.

FIG. 3 illustrates an instruction fetch unit configured according to exemplary aspects.

FIG. 4 illustrates a fetch bandwidth predictor (FBWP) of the instruction fetch unit shown in FIG. 3.

FIG. 5 illustrates a method of fetching one or more instructions according to exemplary aspects.

FIG. 6 illustrates a block diagram of a system configured to support certain techniques as taught herein, in accordance with certain example implementations.

FIG. 7 illustrates an exemplary wireless device in which an aspect of the disclosure may be advantageously employed.

### DETAILED DESCRIPTION

Aspects of the invention are disclosed in the following description and related drawings directed to specific aspects of the invention. Alternative aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects relate to reducing power consumed by instruction fetch units configured to fetch one or more instructions in each clock cycle or pipeline stage of a processor (e.g., a superscalar processor which can support fetching and execution of one or more instructions per clock cycle). Specifically, some aspects pertain to eliminating wastage of power caused by unnecessary fetching of instructions (e.g., the type 1 and type 2 instructions described in the background sections) which will be eventually discarded due to a change of control flow caused by instructions such as branch instructions which are predicted to be taken.

For example, it is recognized that the number of instructions fetched in each clock cycle of a processor can be adjusted such that instructions that will be eventually discarded are not fetched. Thus, if a maximum number (also referred to as maximum bandwidth (BW)) of two or more instructions can be fetched and processed in a processor in each clock cycle, in exemplary aspects, less than the maximum number of instructions can be fetched and processed in at least one clock cycle of the processor.

In order to avoid wasteful fetching of instructions, exemplary aspects include a fetch bandwidth predictor (FBWP) which is configured to predict a correct number of instructions in a fetch group or fetch quantum that should be fetched from an instruction cache in each cycle. Fetching the predicted correct number of instructions (which can be less than the maximum number) avoids fetching instructions (e.g., the type 1 and type 2 instructions) which will eventually be discarded, thus resulting in power savings.

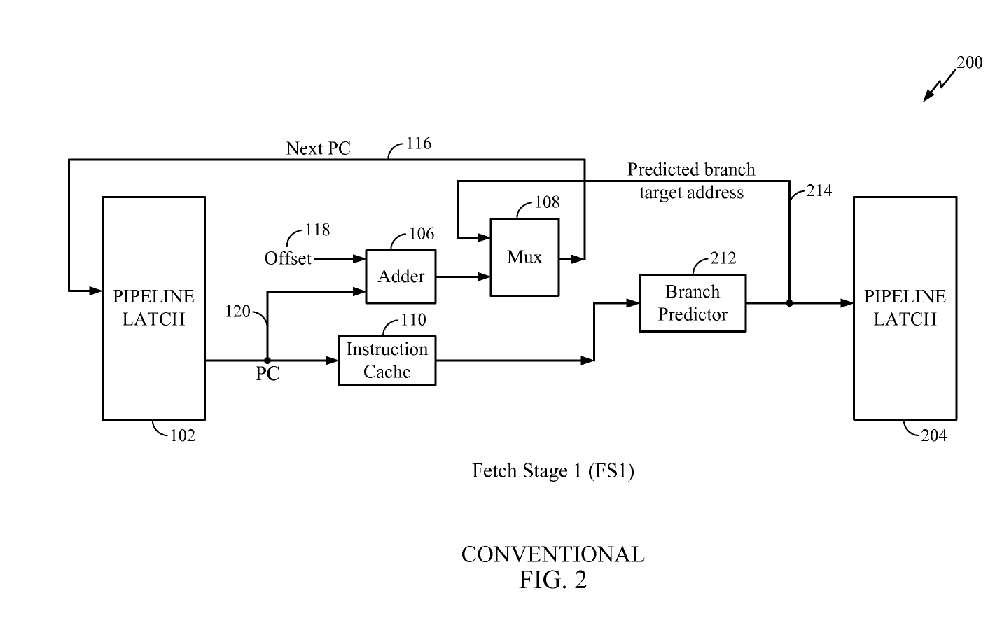

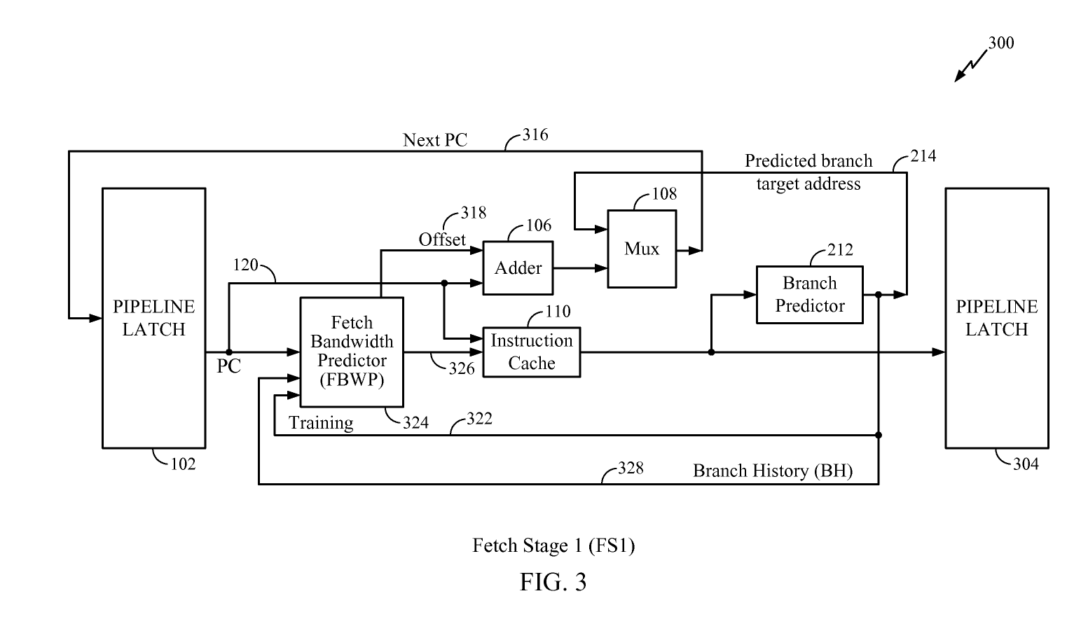

With reference to FIG. 3, instruction fetch unit 300 of a processor, configured according to exemplary aspects, is illustrated. Although further details of the processor are not shown in FIG. 3, the processor may be a superscalar processor or any other processor which can support fetching and execution of one or more instructions, in parallel, for example in a clock cycle or pipeline stage. For purposes of explanation, instruction fetch unit 200 of FIG. 2 is used as a starting point to explain exemplary features of instruction fetch unit 300 of FIG. 3. Accordingly, like reference numerals have been retained from FIG. 2 for similar components in FIG. 3, while different reference numerals are used in FIG. 3 for components which have significant differences from FIG. 2 for the purposes of this disclosure.

Instruction fetch unit 300 is also configured as a single cycle fetch unit with fetch stage 1 formed between pipeline latches 102 and 304. Access of instruction cache 110 and obtaining predicted branch target address 214 from branch predictor 212 takes place in fetch stage 1, which leads to elimination of wasteful fetching of type 2 instructions, similar to instruction fetch unit 200 of FIG. 2. Additionally, fetch stage 1 of instruction fetch unit 300 includes fetch bandwidth predictor (FBWP) 324 configured to generate a prediction of a correct number of instructions to be fetched in each cycle, in order reduce or eliminate wasteful fetching of type 1 instructions as well. The signal, predicted fetch BW 326 from FBWP 324, represents this prediction of the correct number of instructions to be fetched. The prediction, predicted fetch BW 326, is based on factors such as the occurrence and location of an instruction predicted to change control flow of one or more instructions in a fetch group, such as a predicted taken branch instruction in the fetch group. Using predicted fetch BW 326, less than the maximum number of instructions that can be fetched in a fetch group (also referred to as the maximum bandwidth (BW)), are fetched from instruction cache 110. Offset 318 (based on the predicted fetch bandwidth) is generated by FBWP 324 and provided to adder 106, where adder 106 is configured to add offset 318 and current PC 120 to generate next PC 316. Next PC 316, which indicates the starting address from which to fetch a subsequent group of instructions, is based on the output of mux 108, which selects between the output of adder 106 or predicted branch target address 214 depending on whether there was a predicted taken branch instruction in a current fetch group.

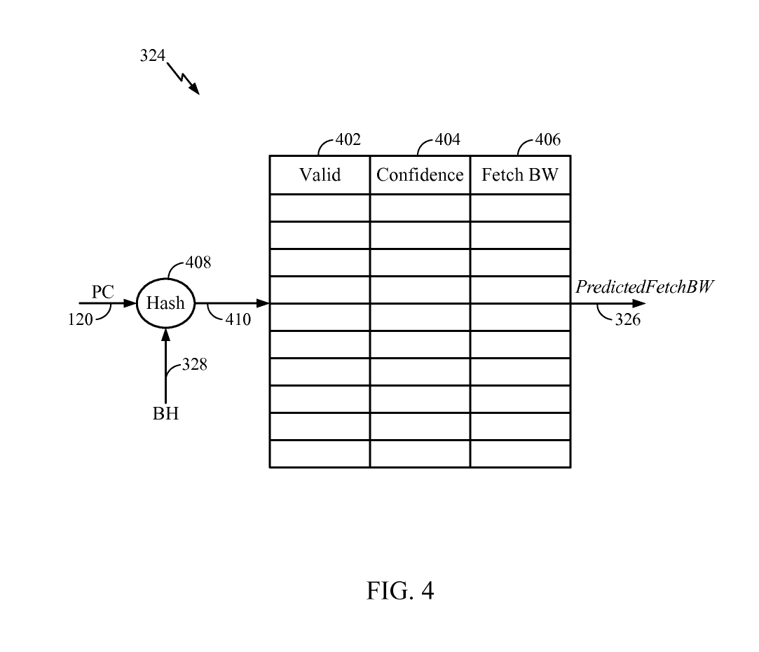

FBWP 324 will be explained further with combined references to FIGS. 3 and 4. FIG. 4 shows a detailed view of FBWP 324. FBWP 324 is configured to store information regarding occurrence and location of predicted taken branch instructions in various fetch groups. Based on the information, FBWP 324 is configured to output predicted fetch BW 326, which is a prediction of the correct number of instructions to be fetched in a particular clock cycle. FBWP 324 may be designed as an indexed or tagged table with one or more entries. FBWP 324 may be indexed using a function of the instruction address or program counter (PC) 120 and branch history (BH) 328. BH 328 may be a global branch history obtained from branch predictor 212. For example, index 410 may be formed by hash logic implemented by the block illustrated as hash 408, to index FBWP 324 using a hash of PC 120 and BH 328. Hash 408 may implement any hash function known in the art, such as exclusive-or, concatenation, or other combination of some or all bits of PC 120 and BH 328 (e.g., a hash of one or more low order bits of PC 120 and one or more bits of BH 328 corresponding to the most recent branch history).

Information for a particular fetch group is stored in a corresponding entry of FBWP 324. The information stored in each entry of FBWP 324 may be include three fields: valid 402, confidence 404, and fetch bandwidth (BW) 406, which will be described below.

The first field, valid 402 may comprise a valid bit to indicate whether the corresponding entry of FBWP 324 has been trained or not (details about training FBWP 324 will be provided in the following sections).

The second field, confidence 404 indicates a confidence level of predicted fetch BW 326. A confidence counter (not specifically shown) may be implemented to increment or decrement the value of confidence 404. The confidence counter may be a saturating counter which can be incremented until it saturates at a ceiling value and decremented until it saturates at a floor value. For example, the confidence counter may be a 2-bit saturating counter with a floor value of “00” and a ceiling value of “11.” The 2-bit saturating counter can be initialized to a value of “00” (or decimal value of 0) and incremented as confidence level increases, until it reaches a value of “11” (or decimal value of 3) and decremented with decreasing confidence, until it reaches the value of “00.” Aspects of how confidence is increased/decreased will be described in the following sections.

The third field, fetch BW 406 comprises the value which will be output as predicted fetch BW 326 for a particular entry if valid 402 for that entry is set. In exemplary aspects, predicted fetch BW 326 available from fetch BW 406 of a particular entry of FBWP 324 may be considered to be valid only if valid 402 is set for the entry (to indicate that FBWP 324 is trained) and confidence 404 for the entry indicates a confidence level above a predetermined threshold (e.g., the predetermined threshold value may be “10” (or decimal value of 2) for the 2-bit saturating counter described above).

As previously described, PC 120 is the address from where a group of instructions will be fetched from instruction cache 110 in a particular clock cycle (e.g., cycle 1). BH 328 comprises a history of directions (e.g., taken or not-taken) of a number of past branch instructions. BH 328 may be obtained from branch predictor 212, for example, from a branch history register (not specifically shown) of branch predictor 212. Branch predictor 212 may be configured according to conventional techniques for branch prediction, where the direction of a branch instruction may be predicted as taken or not-taken, based, for example, on aspects such as the past behavior of the branch instruction (local history), past behaviors of other branch instructions (global history), or combinations thereof. Accordingly, further details of branch predictor 212 will not be provided in this disclosure, as they will be apparent to one skilled in the art.

A particular value of index 410 obtained from hash 408 based on PC 120 and BH 328 will point to an indexed entry. The indexed entry for a first fetch group will be referred to as a first entry in this disclosure for ease of description, while keeping in mind that the first entry may be any entry of FBWP 324 that is pointed to by index 410. FBWP 324 is designed to output predicted fetch BW 326, based on values of the fields valid 402, confidence 404, and fetch BW 406 for the first entry. The prediction of the number of instructions to be fetched in the first fetch group of instructions, is based at least in part on the occurrence and location of a predicted taken branch instruction in the first fetch group. Predicted fetch BW 326 corresponds to a number of instructions in a fetch group that should be fetched from instruction cache 110 in cycle 1, which would avoid wasteful fetching of instructions (e.g., type 1 instructions in this case). If the processor (not shown, for which instruction fetch unit 300 is configured) is designed to fetch a maximum number of instructions or “maximum fetch BW” in each cycle, then predicted fetch BW 326 will be less than or equal to the maximum fetch BW.

With combined reference now to FIGS. 3-4, using predicted fetch BW 326 output from FBWP 324 and PC 120, instruction cache 110 is accessed in cycle 1 to fetch a group of a number of instructions indicated by predicted fetch BW 326, starting from the address indicated by PC 120. The fetched group of instructions from instruction cache 110 will be provided to branch predictor 212. Branch predictor 212 will search for the occurrence of any branch instructions (e.g., the previously mentioned branch instruction I2) in the fetched group of instructions. Information regarding any taken or not-taken branch instructions that may be found in the fetch group is supplied through the signal depicted as training 322 to FBWP 324. Training 322 includes an updated value for fetch BW 406 and an indication of whether confidence 404 is to be incremented or decremented. The fields of FBWP 324 are updated or said to be trained based on this information, to improve its predictions of predicted fetch BW 326. The training process will be described in detail in the following sections. The fetched group of a number of instructions corresponding to predicted fetch BW 326 will be supplied to subsequent pipeline stages (not shown) to be processed accordingly in the processor.

Training FBWP 324 may be a continuous process based on feedback provided by branch predictor 212 via training 322, comprising values for fetch BW 406 and an indication of whether confidence 404 is to be incremented or decremented. Under initial conditions (e.g., after a cold start of the processor) when there has been no training, valid 402 for all entries will be cleared or set to “0”; confidence 404 may also be “0” or a base/floor value; and fetch BW 406 will be set to a default value equal to the maximum fetch BW. Thus, under initial conditions, predicted fetch BW 326 will be equal to the maximum fetch BW. In the previous example where the group of instructions in each fetch cycle was shown to be 5, the maximum fetch BW would be 5 and so all 5 instructions will be fetched. The entries of FBWP 324 will be updated based on presence of branch instructions in fetch groups. As long as branch instructions are not encountered to update an entry, the initial or default values will remain for that entry.

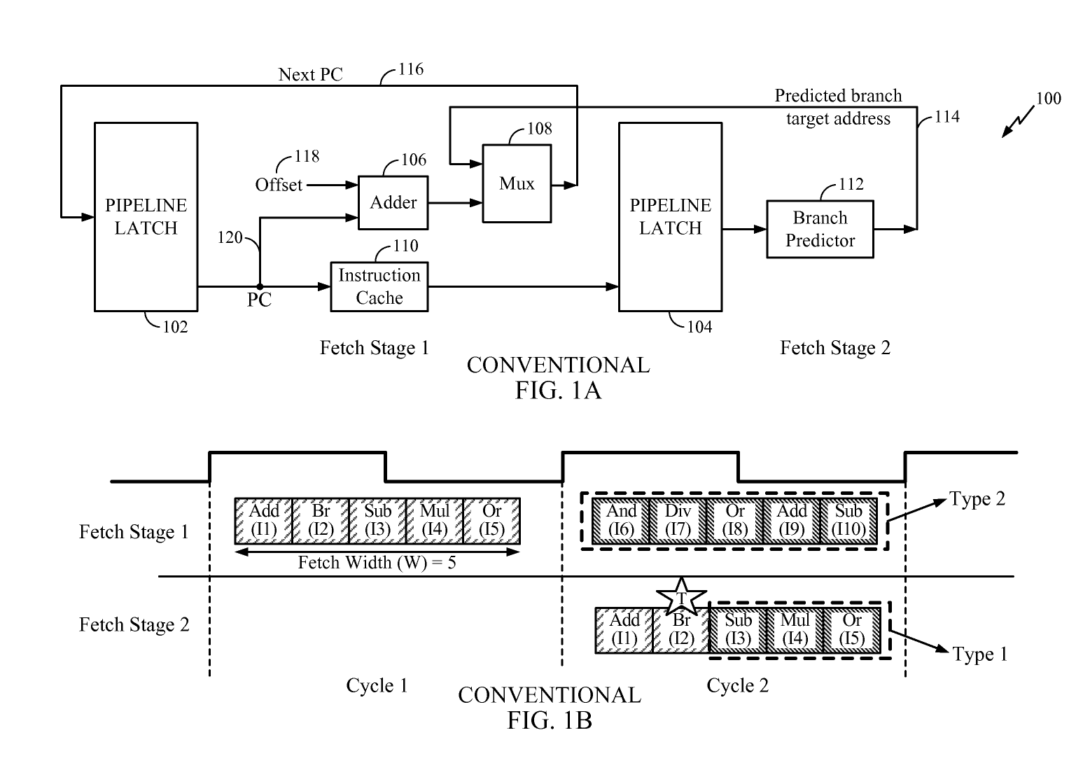

Entries of FBWP 324 will be populated based on a location of a first encountered branch instruction which is predicted to be taken. Considering, once again, the previous example (referring to FIG. 1B), if the second instruction I2 in a fetched group of 5 instructions is the first encountered branch instruction whose direction is predicted by branch predictor 212 as taken, then fetch BW 406 of a corresponding entry in FBWP 324 (e.g., the indexed entry or “first entry” corresponding to index 410 output from hash 408 based on at least a portion of bits of PC 120 (e.g., one or more low order bits) for the first instruction in the fetched group (e.g., I1) and one or more bits of BH 328 (which may also be initialized to “0”)) will be updated with “2” (to indicate that the second instruction in the group is a predicted taken branch instruction). Correspondingly, valid 402 for the first entry will be set to “1”. Confidence 404 for the first entry will be incremented.

In general, FBWP 324 is considered to be sufficiently trained when confidence 404 is incremented in this manner, beyond a predetermined threshold (e.g., 2 for a 2-bit saturating counter, for example). Once FBWP 324 is sufficiently trained, if a fetch group is encountered with the aforementioned first instruction (e.g., a fetch group with the first instruction I1 is encountered, based for example, on PC 120 indicating that the start address for the fetch group corresponds to the first instruction I1), FBWP 324 is accessed to obtain predicted fetch BW 326 from fetch BW 406 of the first entry. Predicted fetch BW 326 will be 2 in this example, which causes only 2 instructions to be fetched from instruction cache 110 in the fetch group, rather than the maximum or default number of 5 instructions. Fetching only 2, rather than 5 instructions will avoid fetching the type 1 instructions (I3, I4, and I5), thus avoiding wasteful fetching and related power wastage in exemplary aspects.

In some cases, the behavior of FBWP 324 may deviate from the above example, and predicted fetch BW 326 may not be the correct number of instructions to be fetched (i.e. predicted fetch BW 326 may not be the correct fetch BW) in a particular fetch group. These cases are referred to as mispredictions of FBWP 324. The mispredictions can be of two types. A first type of misprediction is an over-prediction, where FBWP 324 may overestimate the number of instructions to be fetched (i.e., predicted fetch BW 326 is greater than the correct fetch BW). A second type of misprediction is an under-prediction, where FBWP 324 may underestimate the number of instructions to be fetched (i.e., predicted fetch BW 326 is less than the correct fetch BW). For both types of mispredictions, confidence 404 for a corresponding entry is decremented (e.g., until a floor value is reached in a saturating counter implementation of confidence 404). Additional details regarding these two types of mispredictions, including exemplary aspects of handling these mispredictions and updating predicted fetch BW 326 for different cases, will now be provided.

The first type of misprediction or over-prediction occurs in cases where the number of instructions fetched in a group based on predicted fetch BW 326 is at least one more than the correct number. For example, considering a first fetch group, at least one instruction in the first fetch group would be a type 1 instruction that will result in wastage because it was fetched after a predicted taken branch instruction in the same, first fetch group. In other words, there will be a predicted taken branch in the first fetch group within a number of instructions which is less than or equal to predicted fetch BW 326 minus one. Revisiting the above-described example for a first entry corresponding to the first fetch group, an over-prediction is said to occur when the first entry of FBWP 324 is valid (i.e., valid 402 for the first entry is set to “1”) and if predicted fetch BW 326 is 3 or more, which causes the predicted taken branch (I2) to occur within 3−1=2 instructions in the fetch group. Thus, instruction I3 would have been fetched unnecessarily in this case. Accordingly, when there is an over-prediction, the value in confidence 404 for the first entry is decremented by 1 (e.g., by decrementing the saturating confidence counter). Based on the location of the predicted branch instruction (e.g., I2) in the fetch group, fetch BW 406 for the first entry is updated (e.g., to 2 instructions, where it may have previously been set to 3, which caused the over-prediction). This update can happen through training 322 (which, as previously mentioned, includes the updated value for fetch BW 406 and an indication of whether confidence 404 is to be incremented or decremented). The update through training 322 can happen in the same cycle in which the over-prediction occurred and a predicted taken branch instruction was discovered within a smaller number of instructions than were fetched. The next time the first entry is accessed using the address (PC value) of the first fetch group, FBWP 324 will be able to provide a more accurate prediction of predicted fetch BW 326 based on the update.

The second type of misprediction or under-prediction occurs in cases where branch instructions (if any) in the first fetch group of instructions are not predicted to be taken (or a predicted to be not-taken) by branch predictor 212. It is assumed that for under-prediction to occur, predicted fetch BW 326 is less than the maximum fetch BW and that the corresponding first entry for which under-prediction occurs is valid. Returning to the above example, if, predicted fetch BW 326 for the first entry was 2 (which is less than the maximum fetch BW of 5) and valid 402 for the first entry is set to “1”, but branch instruction I2 was predicted to be not-taken by branch predictor 212 in a particular clock cycle (e.g., cycle 1), then under-prediction is said to have occurred. Confidence 404 for the first entry will decremented by “1” in this case as well (e.g., through training 322). While more instructions could have been fetched in the case of under-prediction, it is seen that there is no wastage of instructions that were fetched in the first fetch group in the case of under-prediction.

Unlike over-prediction described above, in the case of under-prediction, updating FBWP 324 (or specifically, fetch BW 406 of the first entry) does not take place in the same cycle, but occurs in a following cycle such as cycle 2. The update will use the address of the first fetch group and a number of instructions fetched in a subsequent, second fetch group in cycle 2. In further detail, in cycle 2, the number of instructions to fetch in the second fetch group is predicted/set to be the maximum BW (i.e., 5). Thus, in cycle 2, the maximum BW of instructions are fetched and it is determined whether there is a predicted taken branch in the second fetch group. Thus, 5 instructions past I2, i.e., I3, I4, I5, I6, and I7 will be fetched in the second fetch group. If there is a predicted taken branch instruction in the second fetch group (say, for example, I4 is a predicted taken branch instead of being a multiply instruction as depicted in FIG. 1B), then fetch BW 406 for the first entry corresponding to the first fetch group is updated to an number=4, which is obtained by adding 2 instructions fetched in the first fetch group and the location in which the predicted taken branch appeared in the second fetch group (I4 appears in the second location among the 5 instructions fetched). Furthermore, another entry (say, a “second entry”) which is indexed by the second fetch group (based on the address or PC value of first instruction I3 of the second fetch group) will also be updated with the value 2 to indicate that within the second fetch group, I4 appears in the second position. Thus, the next time the first entry corresponding to the first fetch group is accessed, fetch BW 406 will have a value of 4, which shows that there is a predicted taken branch (I4) in the fourth location, and so only 4 instructions are indicated to be fetched by predicted fetch BW 326. When the second entry corresponding to the second fetch group is accessed, 2 instructions will be indicated by predicted fetch BW 326.

It will be noted that if the predicted taken branch instruction is either located in a position beyond the location that can be fetched within the maximum BW in the first fetch group (e.g., if I6 or I7 is the predicted taken branch instruction, rather than I4, then I6 or I7 cannot be fetched in the first fetch group as the maximum fetch BW is only 5), or if the second fetch group does not contain the predicted taken branch instruction, then the fetch BW 406 of the first entry corresponding to the first fetch group is updated to the maximum fetch BW.

Accordingly, in exemplary aspects, once FBWP 324 is sufficiently trained, wasteful fetching of instructions (e.g., type 1 instructions) is mitigated. Above-described mechanisms continually train FBWP 324 in cases of under-prediction and over-prediction.

Although not discussed in detail, alternative implementations are possible, wherein instruction fetch unit 300 may be further pipelined to obtain predicted fetch BW 326 in a first cycle and access instruction cache 110 and branch predictor 212 in a subsequent, second cycle. For example, access of instruction cache 110 and branch predictor 212 may be placed outside fetch stage 1, for example, to the right hand side of pipeline latch 304 in FIG. 3, wherein FBWP 324 would remain in fetch stage 1. Considering other suitable modifications as necessary for this setup, instruction fetch unit 300 would essentially be implemented as a two-stage pipeline, where FBWP 324 is accessed in fetch stage 1 to get a prediction of the number of instructions to fetch in fetch stage 2 from instruction cache 110. Notice that there will be no wastage of type 1 as well as type 2 instructions because instruction cache 110 is still accessed in the same cycle as branch predictor 212 (eliminating type 2 wastage), and instruction cache 110 is accessed after predicted fetch BW 326 is available from the previous cycle (eliminating type 1 wastage). This two stage implementation can be used where cycle time between pipeline stages is limited or higher frequency operation is desired.

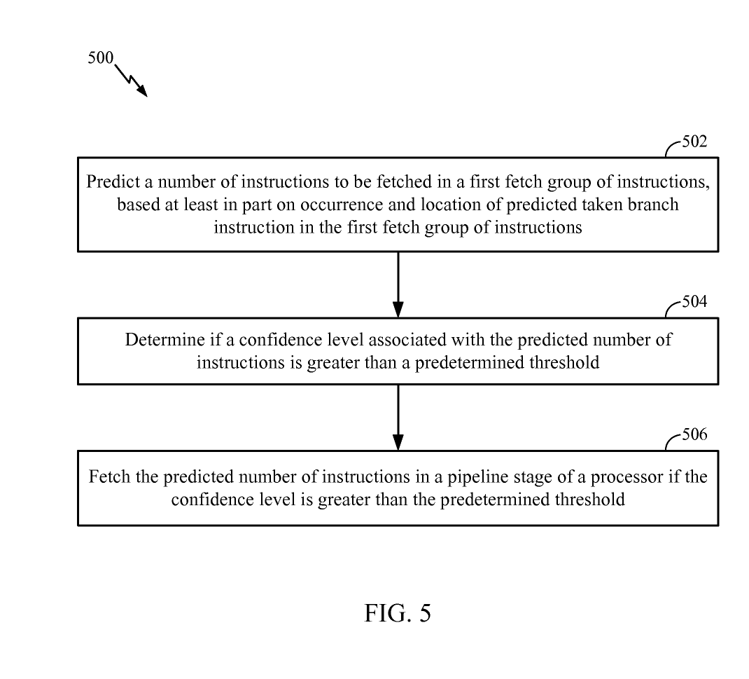

Accordingly, it will be appreciated that exemplary aspects include various methods for performing the processes, functions and/or algorithms disclosed herein. For example, FIG. 5 illustrates a method 500 for fetching instructions for a processor (e.g., a superscalar processor).

In Block 502, method 500 comprises predicting a number of instructions to be fetched in a first fetch group of instructions, based at least in part on occurrence and location of a predicted taken branch instruction in the first fetch group of instructions. For example, by indexing FBWP 324 based on an a function (e.g., implemented by hash 408) of PC 120 (where PC 120 corresponds to the address of the fetch group, and more specifically to the address of the first instruction (e.g., I1) of the fetch group) and BH 328 corresponding to a history of branch instructions, the first entry of FBWP 324 for the first fetch group (e.g., a “first entry”) is read out. The first entry comprises a prediction in the field fetch BW 406 which includes a predicted number of instructions to fetch based at least in part on occurrence and location of predicted taken branch instruction I2 in the fetch group or fetch group of instructions.

In Block 504, method 500 includes determining if a confidence level associated with the predicted number of instructions is greater than a predetermined threshold. For example, confidence 404 is read out for the first entry and it is determined whether confidence 404 is greater than a predetermined threshold.

In Block 506, method 500 comprises fetching the predicted number of instructions in a pipeline stage of the processor if the confidence level is greater than the predetermined threshold. For example, instruction fetch unit 300 is configured to read out the predicted number of instructions (obtained from predicted fetch BW 326 comprising fetch BW 406 for the first entry) from instruction cache 110 if the confidence level in confidence 404 is greater than the predetermined threshold.

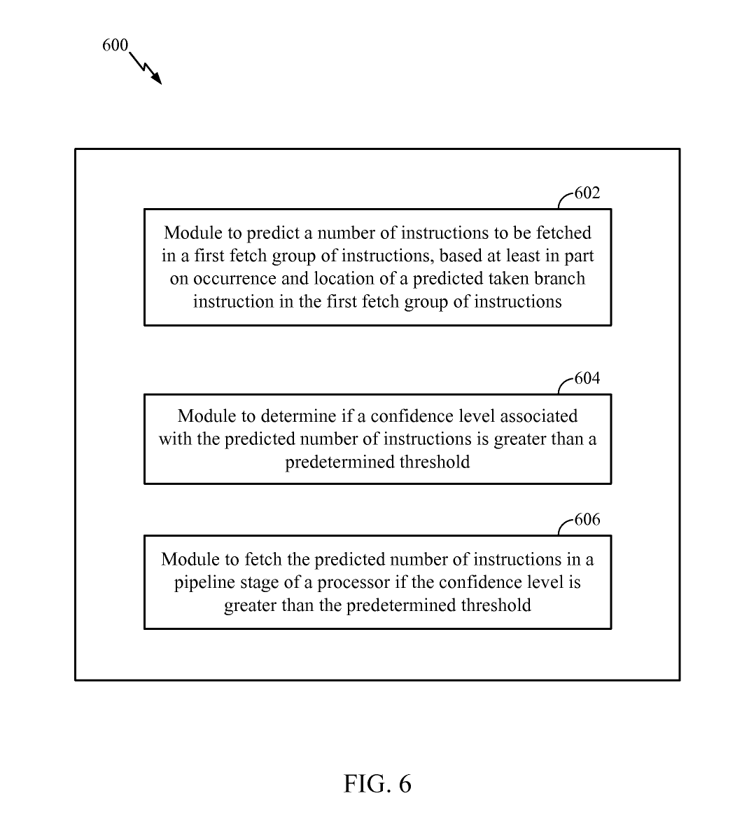

With reference to FIG. 6, an example implementation of system 600 is shown. System 600 may correspond to or comprise a processor (e.g., a superscalar processor) for which instruction fetch unit 300 is designed in exemplary aspects. System 600 is generally depicted as comprising interrelated functional modules. These modules may be implemented by any suitable logic or means (e.g., hardware, software, or a combination thereof) to implement the functionality described below.

Module 602 may correspond, at least in some aspects to, module, logic or suitable means for predicting a number of instructions to be fetched in a first fetch group of instructions, based at least in part on occurrence and location of a predicted taken branch instruction in the first fetch group of instructions. For example, module 602 may include a table such as FBWP 324 and more specifically, the first entry comprising the predicted number in the field, fetch BW 406.

Module 604 may include module, logic or suitable means for determining if a confidence level associated with the predicted number of instructions is greater than a predetermined threshold. For example, module 604 may include a confidence counter which can be incremented or decremented to indicate the confidence level in confidence 404 of the first entry in FBWP 324, and comparison logic (not shown specifically) to determine if the value of confidence 404 is greater than a predetermined threshold.

Module 604 may include module, logic or suitable means for fetching the predicted number of instructions in a pipeline stage of a processor if the confidence level is greater than the predetermined threshold. For example, module 604 may include instruction fetch unit 300 configured to read out the predicted number of instructions (obtained from predicted fetch BW 326 comprising fetch BW 406 for the first entry) from instruction cache 110 if the confidence level in confidence 404 is greater than the predetermined threshold.

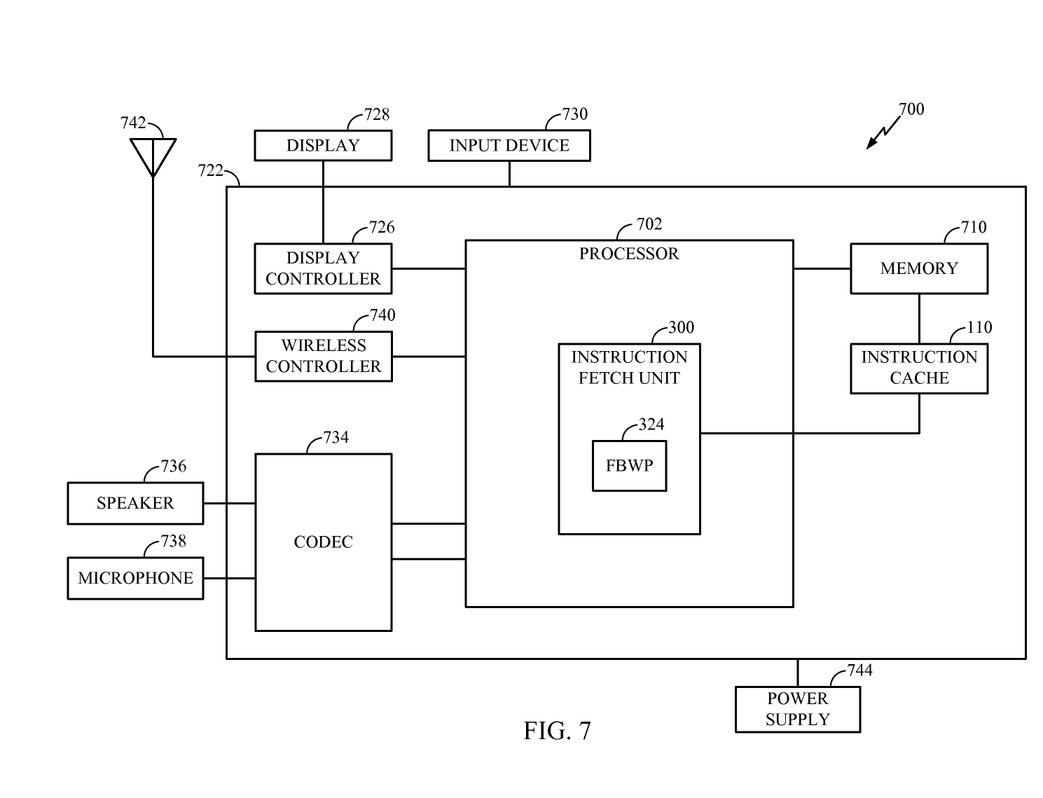

An example apparatus in which instruction fetch unit 300 may be deployed will now be discussed in relation to FIG. 7. FIG. 7 shows a block diagram of a wireless device that is configured according to exemplary aspects is depicted and generally designated 700. Wireless device 700 includes processor 702, which may correspond in some aspects to the processor described with reference to system 600 of FIG. 6 above. Processor 702 may be a designed as superscalar processor in some aspects, and may comprise instruction fetch unit 300 of FIG. 3. In this view, only FBWP 324 is shown in instruction fetch unit 300 while the remaining details provided in FIG. 3 are omitted for the sake of clarity. Processor 702 may be communicatively coupled to memory 710, which may be a main memory. Instruction cache 110 is shown to be in communication with memory 710 and with instruction fetch unit 300 of processor 702. Although illustrated as a separate block, in some cases, instruction cache 110 may be part of processor 702 or implemented in other forms that are known in the art. According to one or more aspects, FBWP 324 may be configured to provide predicted fetch BW 326 to enable instruction fetch unit 300 to fetch a correct number of instructions from instruction cache 110 and supply the correct number of instructions to be processed in an instruction pipeline of processor 702.

FIG. 7 also shows display controller 726 that is coupled to processor 702 and to display 728. Coder/decoder (CODEC) 734 (e.g., an audio and/or voice CODEC) can be coupled to processor 702. Other components, such as wireless controller 740 (which may include a modem) are also illustrated. Speaker 736 and microphone 738 can be coupled to CODEC 734. FIG. 7 also indicates that wireless controller 740 can be coupled to wireless antenna 742. In a particular aspect, processor 702, display controller 726, memory 710, instruction cache 110, CODEC 734, and wireless controller 740 are included in a system-in-package or system-on-chip device 722.

In a particular aspect, input device 730 and power supply 744 are coupled to the system-on-chip device 722. Moreover, in a particular aspect, as illustrated in FIG. 7, display 728, input device 730, speaker 736, microphone 738, wireless antenna 742, and power supply 744 are external to the system-on-chip device 722. However, each of display 728, input device 730, speaker 736, microphone 738, wireless antenna 742, and power supply 744 can be coupled to a component of the system-on-chip device 722, such as an interface or a controller.

It should be noted that although FIG. 7 depicts a wireless communications device, processor 702, memory 710, and instruction cache 110 may also be integrated into a device such as a set top box, a music player, a video player, an entertainment unit, a navigation device, a personal digital assistant (PDA), a fixed location data unit, a computer, a laptop, a tablet, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for predicting a correct number of instructions to fetch in each cycle for a processor. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of fetching instructions for a processor, the method comprising;
predicting a number of instructions to be fetched in a first fetch group of instructions, based at least in part on occurrence and location of a predicted taken branch instruction in the first fetch group;
determining if a confidence level associated with the predicted number of instructions is greater than a predetermined threshold; and
fetching the predicted number of instructions in a pipeline stage of the processor if the confidence level is greater than the predetermined threshold.

2. The method of claim 1, wherein the predicted number of instructions is less than the maximum number of instructions that can be fetched in the pipeline stage.

3. The method of claim 1, comprising fetching the predicted number of instructions from an instruction cache associated with the processor.

4. The method of claim 1, wherein the predicted taken branch instruction is an instruction predicted to change control flow of one or more instructions in the first fetch group.

5. The method of claim 1, comprising determining the occurrence and location of the predicted taken branch instruction in the first fetch group from a table comprising information regarding occurrence and location of predicted taken branch instructions in fetch groups.

6. The method of claim 5, wherein the information for the first fetch group is stored in a first entry of the table.

7. The method of claim 6, comprising accessing the first entry based on an address of a first instruction of the first fetch group and a history of branch instructions.

8. The method of claim 6, wherein the information for the first fetch group stored in the first entry comprises an indication of whether the first entry is valid, a confidence level, and a location of the predicted taken branch instruction in the first fetch group.

9. The method of claim 8, comprising training the first entry by increasing or decreasing the confidence level based on whether the predicted number of instructions is correct or incorrect, respectively.

10. The method of claim 9, comprising determining that the predicted number of instructions is incorrect when the predicted number comprises an over-prediction, wherein the predicted taken branch instruction in the first fetch group is located within a smaller number of instructions in the first fetch group than the predicted number of instructions.

11. The method of claim 10 comprising updating the location of the predicted taken branch instruction in the first entry to indicate the smaller number of instructions in the first fetch group.

12. The method of claim 9, comprising determining that the predicted number is incorrect when the predicted number comprises an under-prediction, wherein the predicted taken branch instruction is not located within the first fetch group.

13. The method of claim 12 further comprising determining that the predicted taken branch instruction is located in a second fetch group and updating the location of the predicted taken branch instruction in the first entry corresponding to the first fetch group based on the predicted number of instructions for the first fetch group and the location of the predicted taken branch instruction in the second fetch group.

14. The method of claim 12 further comprising determining either that the location of the predicted taken branch instruction in the second fetch group is beyond a location that can be fetched in the first fetch group, or the second fetch group does not contain a predicted taken branch instruction, and updating the location of the predicted taken branch instruction in the first entry to indicate the maximum number of instructions that can be fetched in the first fetch group.

15. An instruction fetch unit for a processor, the instruction fetch unit comprising:
a fetch bandwidth predictor (FBWP) configured to predict a number of instructions to be fetched in a first fetch group of instructions in a pipeline stage of the processor, wherein a first entry of the FBWP corresponding to the first fetch group comprises:
a prediction field comprising a prediction of the number of instructions to be fetched, based at least in part on occurrence and location of a predicted taken branch instruction in the first fetch group; and
a confidence level associated with the predicted number in the prediction field;
wherein the instruction fetch unit is configured to fetch the predicted number of instructions in the pipeline stage if the confidence level is greater than a predetermined threshold.

16. The instruction fetch unit of claim 15, wherein the predicted number of instructions is less than the maximum number of instructions that can be fetched in the pipeline stage.

17. The instruction fetch unit of claim 15, wherein the first entry of the FBWP is accessed based on a function of an instruction address of a first instruction of the first fetch group and history of prior branch instructions.

18. The instruction fetch unit of claim 17, wherein the FBWP comprises hash logic to implement the function.

19. The instruction fetch unit of claim 15, wherein the FBWP comprises a confidence counter to indicate the confidence level, wherein the confidence counter is incremented or decremented based on whether the predicted number in the prediction field is correct or incorrect respectively.

20. The instruction fetch unit of claim 19, wherein the predicted number is incorrect when the predicted number comprises an over-prediction, wherein the predicted taken branch instruction is located within a smaller number of instructions in the first fetch group than the predicted number.

21. The instruction fetch unit of claim 19, wherein the predicted number is incorrect when the predicted number comprises an under-prediction, wherein the predicted taken branch instruction is not located within the first fetch group.

22. The instruction fetch unit of claim 15, wherein the processor is a superscalar processor.

23. The instruction fetch unit of claim 15 integrated into a device selected from the group consisting of a set top box, music player, video player, entertainment unit, navigation device, communications device, personal digital assistant (PDA), fixed location data unit, and a computer.

24. A system comprising:
means for predicting a number of instructions to be fetched in a first fetch group of instructions, based at least in part on occurrence and location of a predicted taken branch instruction in the first fetch group of instructions;
means for determining if a confidence level associated with the predicted number of instructions is greater than a predetermined threshold; and
means for fetching the predicted number of instructions in a pipeline stage of a processor if the confidence level is greater than the predetermined threshold.

25. The system of claim 24, wherein the predicted number of instructions is less than the maximum number of instructions that can be fetched in the pipeline stage.

26. A non-transitory computer-readable storage medium comprising code, which, when executed by a processor, causes the processor to perform operations for fetching instructions, the non-transitory computer-readable storage medium comprising:
code for predicting a number of instructions to be fetched in a first fetch group of instructions, based at least in part on occurrence and location of a predicted taken branch instruction in the first fetch group;
code for determining if a confidence level associated with the predicted number of instructions is greater than a predetermined threshold; and
code for fetching the predicted number of instructions from an instruction cache if the confidence level is greater than the predetermined threshold.

27. The non-transitory computer-readable storage medium of claim 26, wherein the predicted number of instructions is less than the maximum number of instructions that can be fetched in a pipeline stage.

28. The non-transitory computer-readable storage medium of claim 26, comprising code for determining the occurrence and location of the predicted taken branch instruction in the first fetch group from a table comprising information regarding occurrence and location of predicted taken branch instructions in fetch groups.

29. The non-transitory computer-readable storage medium of claim 28, comprising code for accessing a first entry of the table comprising information regarding occurrence and location of predicted taken branch instructions in the first fetch group, based on an address of a first instruction of the first fetch group and a history of branch instructions.

30. The non-transitory computer-readable storage medium of claim 29, comprising code for training the first entry by increasing or decreasing the confidence level based on whether the predicted number of instructions is correct or incorrect, respectively.
